(19) United States
(12) Patent Application Publication
(10) Pub. No.: US 2025/0320152 A1
(43) Pub. Date: Oct. 16, 2025

(54) OPTICAL GLASS, METHOD FOR PREPARING SAME, AND USE THEREOF

(71) Applicant: CHINA BUILDING MATERIALS ACADEMY CO., LTD., Beijing (CN)

(72) Inventors: Yanhang WANG, Beijing (CN); Xianzi LI, Beijing (CN); Penghui YANG, Beijing (CN); Tao HAN, Beijing (CN); Jiayu LIU, Beijing (CN); Hanzhen ZHU, Beijing (CN); Yesisi WANG, Beijing (CN)

(73) Assignee: CHINA BUILDING MATERIALS ACADEMY CO., LTD., Beijing (CN)

(21) Appl. No.: 18/769,953

(22) Filed: Jul. 11, 2024

(30) Foreign Application Priority Data
Apr. 11, 2024 (CN) 202410435602.3

(51) Int. Cl. C03C 3/253

(52) U.S. Cl. CPC C03C 3/253; C03C 2203/10

(57) ABSTRACT

The present disclosure provides optical glass, a method for preparing same and use thereof. The method includes the steps of: (1) weighing raw materials, and mixing them uniformly, the optical glass includes, in terms of the mass percentage of oxides: 40-50% La₂O₃, 15-25% Nb₂O₅, 10-20% Gd₂O₃, 5-10% GeO₂, 5-10% B₂O₃, 1-6% TiO₂, and 0.1-1% K₂O; and (2) melting a mixed batch to obtain molten glass, and then introducing a gas into the molten glass for atmosphere bubbling, wherein the gas includes an inert gas and a reducing gas; the inert gas has a specific gravity greater than that of air at the same temperature and gas pressure; and the reducing gas makes the molten glass have a redox index of −120 to −5; after stopping the bubbling, homogenizing the molten glass to be clarified with stirring. The technical problem to be solved is how to provide a method for preparing optical glass that allows the obtained optical glass to have not only a high refractive index but also a high light transmittance in a visible light region, thereby facilitating promotion and use.

### TECHNICAL FIELD

The present disclosure belongs to the field of glass, and in particular relates to optical glass, a method for preparing same, and use thereof.

### BACKGROUND

With the development of electronic products and electronic components toward lightness and thinness, portability, high performance, and the like, the field of view of an optical system of electronic products and electronic components manufactured by using the conventional optical glass is affected, resulting in a decrease in the optical clarity of the electronic products and electronic components. Since a refractive index of optical glass is an important parameter affecting the field of view (FOV) of the optical system, and a high refractive index of the optical glass is advantageous for improving the optical clarity of the electronic products and electronic components, high refractive index glass, especially ultra-high refractive index optical glass with a refractive index n_{d} of 2.0 or more, is more and more widely applied.

In the prior art, in order to make the refractive index n_{d} of the optical glass be 2.0 or more, TiO₂ is generally added into the optical glass, however, the preparation of glass containing TiO₂ will undergo a reaction during a melting process and the obtained product glass will be colored more heavily, and thus, the optical glass containing TiO₂ often has poor light transmittance at a wavelength of 420-460 nm; in order to solve the above problems, it has been reported in the literature that: a decolorizing agent fluoride RF₃ component (R is selected from one or two of La or Ga) and a carbon (C) component are added into optical glass for glass decolorization, and melting is performed at a high temperature under nitrogen protection, and a Pt (platinum)-20Rh (rhodium) crucible and a Pt (platinum)-30Rh (rhodium) stirrer are used in the melting process to increase the internal transmittance of the glass; however, the optical glass prepared by this method still has a transmittance of less than 94%.

### SUMMARY

A main object of the present disclosure is to provide optical glass, a method for preparing same, and use thereof, and the technical problem to be solved is how to provide a method for preparing optical glass that allows the obtained optical glass to have not only a high refractive index (n_{d}≥2.0), but also a high light transmittance (internal transmittance≥94.2%) in a visible light region, thereby facilitating promotion and use.

The object of the present disclosure and solving the technical problem thereof are achieved by the following technical solution. According to the present disclosure, a method for preparing optical glass is proposed, wherein the method includes the steps of:
(1) preparation of a mixed batch: weighing raw materials, and mixing them uniformly, the optical glass includes, in terms of the mass percentage of oxides: 40-50% La₂O₃, 15-25% Nb₂O₅, 10-20% Gd₂O₃, 5-10% GeO₂, 5-10% B₂O₃, 1-6% TiO₂, and 0.1-1% K₂O, wherein the sum of mass percentages of La₂O₃, Nb₂O₅, Gd₂O₃, GeO₂ and TiO₂ is 82-92%;
(2) melting: melting the mixed batch to obtain molten glass, and then introducing a gas into the molten glass for atmosphere bubbling, wherein the gas includes an inert gas and a reducing gas; the inert gas has a specific gravity greater than that of air at the same temperature and gas pressure; and the reducing gas makes the molten glass have a redox index of −120 to −5; after stopping the bubbling, homogenizing the molten glass to be clarified with stirring, during the melting process, a container and a stirrer in contact with the molten glass are made of a platinum-containing material; and
(3) glass forming and annealing.

The object of the present disclosure and solving the technical problem thereof can be further achieved by the following technical measures.

Preferably, in the method, the inert gas is selected from at least one of argon, krypton and xenon; and the reducing gas is selected from at least one of hydrogen, nitric oxide, hydrogen sulfide, sulfur monoxide and carbon monoxide.

Preferably, in the method, the inert gas is argon and the reducing gas is hydrogen.

Preferably, in the method, the gas has a hydrogen content of 1-3% by volume, a mixed gas is introduced at a flow rate of 1-4 L/min per liter of the molten glass for 0.5-1 h.

Preferably, in the method, in terms of mass percentage, the optical glass includes 5-8% B₂O₃ and 1-5% TiO₂.

Preferably, in the method, the melting is performed at a temperature of 1380-1420° C. for 5-8 h; and the stirring is performed by using a frame stirrer at a speed of 50-80 rpm for 2-4 h.

Preferably, in the method, the glass forming adopts a leakage forming method, the forming temperature is 1200-1250° C., the glass annealing temperature is 700-750° C., and the annealing time is 8-10 h.

Preferably, in the method, in terms of oxides, the optical glass further includes ZrO₂ Ta₂O, and in terms of mass percentage, ZrO₂ is 1-6% and Ta₂O₅ is 1-6%.

The object of the present disclosure and solving the technical problem thereof are also achieved by the following technical solution. According to the present disclosure, provided is optical glass, including, in terms of the mass percentage of oxides: 40-50% La₂O₃, 15-25% Nb₂O₅, 10-20% Gd₂O₃, 5-10% GeO₂, 5-10% B₂O₃, 1-6% TiO₂, 0.1-1% K₂O, 5-8% B₂O₃, and 1-5% TiO₂, wherein the sum of mass percentages of La₂O₃, Nb₂O₅, Gd₂O₃, GeO₂ and TiO₂ is 82-92%; and the optical glass has a refractive index n_{d} of 2.02 or more and a transmittance of 94.2% or more in a visible light region.

The object of the present disclosure and solving the technical problem thereof are also achieved by the following technical solution. According to the present disclosure, provided is use of the optical glass in the fields of virtual reality, digital cameras or vehicle-mounted display.

With the above technical solutions, the optical glass, the method for preparing same, and the use thereof according to the present disclosure have at least the following advantages:

1. According to the method for preparing the optical glass of the present disclosure, a large amount of La₂O₃, Nb₂O₅, Gd₂O₃, and GeO₂ and a small amount of TiO₂ are contained in the optical glass, and the sum of the mass percentages of La₂O₃, Nb₂O₅, Gd₂O₃, GeO₂ and TiO₂ is 82-92%, thereby enabling the prepared optical glass to realize an ultra-high refractive index (n_{d}≥2.02 at a wavelength of 587.6 nm).

Since TiO₂ not only has the effect of increasing the refractive index of glass, but also can reduce the density of glass to make the glass light and thin, TiO₂ is added to the optical glass in the present disclosure; however, TiO₂ can significantly increase the coloration of the glass, the content of TiO₂ in the optical glass is reasonably used and limited in the present disclosure, and TiO₂ coordinates with other oxides of the present disclosure, so that the optical glass of the present disclosure has an ultra-high refractive index, and the coloration of the glass is reduced, thereby making the ultra-high refractive index optical glass of the present disclosure have good light transmittance in the visible light region; and in addition, the prepared optical glass has a low density, and a product prepared by using the optical glass is easy to be light and thin.

It is inevitable to introduce an impurity Fe with the mixed batch during the preparation of the optical glass, and the impurity Fe can undergo a redox reaction with oxygen (O₂) during the high-temperature melting of the glass to form mainly Fe²⁺ and Fe³⁺. The glass appears brownish-yellow due to the light absorption of Fe³⁺ in the glass in a visible light region near a ultraviolet region; while the absorption of Fe²⁺ is not obvious in the visible light region near the ultraviolet region, and TiO₂ is contained in the optical glass, Fe³⁺ and TiO₂ can form a Fe—O—Ti complex group during high-temperature melting, and the complex group Fe—O—Ti can increase the coloration of the glass. Therefore, in order to make the optical glass of the present disclosure have a high light transmittance in the visible light region, on one hand, the generation of Fe³⁺ is reduced or even avoided; on the other hand, the formation of the Fe—O—Ti complex group in the glass is inhibited or even avoided. A specific solution is as follows:
first, the optical glass according to the present disclosure provides a glass network former with GeO₂ and B₂O₃, avoids containing a SiO₂ component, reduces the melting temperature of the glass and shortens the melting time, thereby inhibiting the reaction of the impurity Fe with the oxygen to form Fe³⁺, while shortening the reaction time of the impurity Fe with the oxygen to reduce the content of Fe³⁺ in the molten glass.

Next, in the high-temperature melting process of the present disclosure, after the mixed batch is melted, the gas is introduced into the molten glass for atmosphere bubbling, wherein the gas includes the inert gas and the reducing gas, and the inert gas has a specific gravity greater than that of air at the same temperature and atmospheric pressure. After the inert gas has escaped from the molten glass, the inert gas can accumulate around the molten glass to form a gas protective layer, avoiding gas exchange between the outside of the molten glass and the inside of the molten glass, blocking oxygen from the outside of the molten glass from entering the inside of the molten glass, and inhibiting the reaction of the impurity Fe in the molten glass with O₂ to form Fe³⁺, and reducing the content of Fe³⁺ in the molten glass also helps to inhibit the complexing reaction of Fe³⁺ with TiO₂, thereby reducing or even avoiding the formation of the Fe—O—Ti complex group in the glass; further, the reducing gas introduced into the molten glass is used to make the molten glass have a redox index of −120 to −5, that is, the molten glass forms a weak reducing environment, which not only helps to inhibit the rate and extent of the redox reaction of the impurity Fe with O₂, but also makes Fe²⁺ in the molten glass less easily oxidized and stably present in the molten glass, thereby reducing or even avoiding the presence of the impurity Fe in the glass in the form of Fe³⁺; and it also helps to inhibit the rate and extent of the complexing reaction of Fe³⁺ with TiO₂, thereby reducing or even avoiding the formation of the Fe—O—Ti complex group in the glass. In addition, a mixed gas of the inert gas and the reducing gas is introduced into the molten glass, and the inert gas forms a gas protective layer around the molten glass, so that some of the reducing gas introduced into the molten glass may diffuse to the outside of the molten glass, resulting in slow formation of the weak reducing environment in the molten glass. Based on the above, the simultaneous introduction of the inert gas and the reducing gas into the molten glass not only helps to rapidly inhibit or avoid the generation of Fe³⁺ and the Fe—O—Ti complex group in the molten glass, but also helps to reduce the amount of the reducing gas used in the melting process, thereby saving costs.

By using the glass preparation method of the present disclosure, the prepared optical glass realizes an ultra-high refractive index (n_{d}≥2.02 at a wavelength of 587.6 nm) and a high light transmittance (internal transmittance≥94.2% at a wavelength of 440 nm) in the visible light region, thereby facilitating promotion and use. 2. The present disclosure also provides a glass preparation method, wherein in addition to La₂O₃, Nb₂O₅, Gd₂O₃, GeO₂ and TiO₂ for providing an ultra-high refractive index, GeO₂ and B₂O₃ for forming a glass network former, and K₂O for increasing whiteness, Ta₂O₅ and ZrO₂ can be added to the optical glass to make the optical glass have alkali resistance stability of A₁ level and acid resistance stability of 1 level, and have good chemical resistance. 3. According to the optical glass of the present disclosure, the optical glass includes, in terms of the mass percentage of oxides: 40-50% La₂O₃, 15-25% Nb₂O₅, 10-20% Gd₂O₃, 5-10% GeO₂, 5-10% B₂O₃, 1-6% TiO₂, 0.1-1% K₂O, 5-8% B₂O₃, and 1-5% TiO₂, wherein the sum of mass percentages of La₂O₃, Nb₂O₅, Gd₂O₃, GeO₂ and TiO₂ is 82-92%; and the optical glass not only has an ultra-high refractive index (n_{d}≥2.02 at a wavelength of 587.6 nm), but also has a high light transmittance (internal transmittance≥94.2% at a wavelength of 440 nm) in the visible light region, and can be used in the fields of virtual reality, digital cameras and vehicle-mounted display.

The above description is only an overview of the technical solutions of the present disclosure, and in order to able to more clearly understand the technical means of the present disclosure and make the present disclosure be implemented according to the contents of the specification, the following detailed description is given by means of the preferred examples of the present disclosure.

### DETAILED DESCRIPTION

In order to further explain the technical means and the effects of the present disclosure in order to achieve the intended inventive objects, preferred examples are provided below, and the optical glass, the method for preparing same, and the use thereof according to the present disclosure, and the specific embodiments thereof are described in detail below. In the following description, different “one example” or “examples” do not necessarily refer to the same example. Furthermore, particular features in one or more examples may be combined in any suitable form.

Most of components used to increase the refractive index of the glass during the preparation of ultra-high refractive index glass have the property of increasing the coloration of the optical glass, and the increase of glass coloration will result in a decrease in the light transmittance of the glass. In order to obtain optical glass which not only has an ultra-high refractive index n_{d}≥², but also has a high light transmittance (internal transmittance≥94%) in a visible light region, the present disclosure provides a method for preparing optical glass that reduces or even avoids the inclusion of components that increase the coloration of the glass in the optical glass, thereby reducing the coloration of the glass and increasing the light transmittance of the glass in the visible light region.

The present disclosure provides a method for preparing optical glass, including the steps of:
(1) preparation of a mixed batch: weighing raw materials, and mixing them uniformly, the optical glass includes, in terms of the mass percentage of oxides: 40-50% La₂O₃, 15-25% Nb₂O₅, 10-20% Gd₂O₃, 5-10% GeO₂, 5-10% B₂O₃, 1-6% TiO₂, and 0.1-1% K₂O, wherein the sum of mass percentages of La₂O₃, Nb₂O₅, Gd₂O₃, GeO₂ and TiO₂ is 82-92%;
(2) melting: melting the mixed batch to obtain molten glass, and then introducing a gas into the molten glass for atmosphere bubbling, wherein the gas includes an inert gas and a reducing gas; the inert gas has a specific gravity greater than that of air at the same temperature and gas pressure; and the reducing gas makes the molten glass have a redox index of −120 to −5; after stopping the bubbling, homogenizing the molten glass to be clarified with stirring, during the melting process, a container and a stirrer in contact with the molten glass are made of a platinum-containing material; and
(3) glass forming and annealing.

According to the method for preparing the optical glass of the present disclosure, GeO₂ and B₂O₃ are essential components for glass formation of the glass of the present disclosure, and the GeO₂ component and the B₂O₃ component are important network formers of the optical glass. Strictly controlling the mass percentage of the GeO₂ component to be 5-10% not only helps to promote the obtaining of homogeneous glass bodies in the present disclosure, but also helps to achieve a high refractive index of the optical glass. If this component is not added, the glass-forming ability becomes poor; if the mass percentage of this component exceeds 10%, the refractive index of the glass decreases. The present disclosure strictly controls the mass percentage of the B₂O₃ component to be 5-10%, which not only makes the prepared optical glass have good glass forming properties, but also helps to improve the refractive index of the optical glass. If the mass percentage of this component is less than 5%, the glass-forming ability becomes poor; if the mass percentage of this component exceeds 10%, the refractive index of the glass decreases. The optical glass of the present disclosure avoids containing the conventional SiO₂ component used for glass formation, so that the melting temperature of the glass is lowered, thereby lowering the generation of Fe³ from the impurity Fe in the molten glass and oxygen, so as to reduce the coloration of the glass.

According to the method for preparing the optical glass of the present disclosure, a large amount of La₂O₃, Nb₂O₅, Gd₂O₃, and GeO₂, and a small amount of TiO₂ contained in the optical glass are all components essential for achieving a high refractive index of the optical glass. When the contents of these components are high, it is advantageous for the glass to achieve an ultra-high refractive index; however, the contents of these components used are also somewhat limited, and specific reasons are as follows:
the La₂O₃ component contributes to the improvement of glass forming properties and the refractive index of the optical glass. The present disclosure uses La₂O₃ as a main component for increasing the refractive index. If the mass percentage of the La₂O₃ component is less than 40%, it is difficult to ensure that the refractive index n_{d} of the optical glass is 2.0 or more. If the mass percentage of the La₂O₃ component exceeds 50%, glass forming properties of the glass will become poor. Strictly controlling the mass percentage of the La₂O₃ component to be 40-50% enables the optical glass of the present disclosure to achieve a high refractive index and good glass forming properties. In addition, the present disclosure uses La₂O₃ as a main component for increasing the refractive index of the optical glass, and compared with other glass components for increasing the refractive index, La₂O₃ is more stable, does not easily undergo redox reactions during melting, has no obvious coloring effect on the glass, and contributes to increasing the overall light transmittance of the glass. Moreover, the price of this component is cheap, so that it is easier for the glass product to achieve mass production.

The Nb₂O₅ component contributes to the improvement of glass forming properties and the refractive index of the optical glass, and also has a positive effect on improving the glass density. The present disclosure strictly controls the mass percentage of this component to be 15-25%, which helps to increase the refractive index of the glass, making it easy for the glass to realize a refractive index n_{d}≥2.0; and the optical homogeneity of the glass is good. If the Nb₂O₅ content is less than 15%, the refractive index of the glass does not increase significantly; and if the Nb₂O₅ content exceeds 25%, it is difficult for this component to sufficiently melt in the molten glass, and the optical homogeneity of the glass becomes poor.

Gd₂O₃ is an essential component for realizing a high refractive index of the optical glass of the present disclosure, if the mass percentage of the Gd₂O₃ component is less than 10%, it is difficult to ensure that the refractive index of the glass is 2.0 or more, and if the mass percentage of the Gd₂O₃ component exceeds 20%, glass forming properties of the glass will become poor. The present disclosure strictly controls the mass percentage of this component to be 10-20%, which is not only beneficial for the optical glass to achieve a high refractive index, but also has better glass forming properties.

Strictly controlling the mass percentage of the GeO₂ component to be 5-10% not only helps to promote the obtaining of homogeneous glass bodies in the present disclosure, but also helps to achieve a high refractive index of the optical glass. If this component is not added, the glass-forming ability of the glass becomes poor; and if the mass percentage of this component exceeds 10%, the refractive index of the glass will decrease.

The TiO₂ component is an essential component for the optical glass of the present disclosure to have a high refractive index, and if the mass percentage of the TiO₂ component is less than 1%, it is difficult to ensure that the refractive index of the glass is 2.0 or more, and if the mass percentage of the TiO₂ component exceeds 6%, the coloration of the glass will be increased, and the light transmittance of the optical glass will be deteriorated. The present disclosure strictly controls the mass percentage of this component to be 1-6%, which is not only advantageous to ensure that the refractive index n_{d} of the glass is 2.0 or more, but also to reduce the coloration of the glass due to TiO₂ and improve the light transmittance of the optical glass in the visible light region. In addition, the addition of the TiO₂ component has a positive effect on lowering the density of the glass, and therefore, a product further prepared by using the optical glass obtained in the present disclosure is easy to be light and thin.

According to the method for preparing the optical glass of the present disclosure, the optical glass further contains K₂O, which is a component essential for improving glass forming properties and whiteness of the glass in the present disclosure, the mass percentage of this component is controlled to be 0.1-1%, and if the mass percentage of the K₂O component is less than 0.1%, it is difficult to ensure glass forming properties and whiteness of the glass; and if the mass percentage of the K₂O component exceeds 1%, the refractive index of the glass decreases.

The present disclosure strictly controls the sum of the mass percentages of the components La₂O₃, Nb₂O₅, Gd₂O₃, GeO₂ and TiO₂ to be 82-92%, enabling the optical glass to achieve a high refractive index (a refractive index n_{d}≥2.02 at a wavelength of 587.6 nm) and good glass forming properties.

The present disclosure further enhances the internal transmittance of the optical glass in the visible light region by optimizing the melting process of the glass.

Due to the inevitable introduction of the impurity Fe with the mixed batch during the preparation of the optical glass, the impurity iron (Fe) can undergo a redox reaction with oxygen (O₂) during the high-temperature melting of the glass, and when oxygen is sufficient and sufficient energy is provided in a reaction environment, the impurity iron (Fe) can undergo a redox reaction with oxygen (O₂) to form Fe³⁺; in contrast, when the oxygen content is insufficient or sufficient energy cannot be provided in the reaction environment, the impurity iron (Fe) can undergo a redox reaction with oxygen (O₂) to form Fe²⁺, which however has poor stability and is easily oxidized to form Fe³⁺. The glass appears brownish-yellow due to the absorption of Fe³⁺ in the glass in the visible light region near the ultraviolet region; while the absorption of Fe²⁺ is not obvious in the visible light region near the ultraviolet region, and TiO₂ is contained in the optical glass, Fe³⁺ and TiO₂ can form a Fe—O—Ti complex group during high-temperature melting, and the complex group Fe—O—Ti can increase the coloration of the glass. Therefore, in order to make the optical glass of the present disclosure have a high light transmittance in the visible light region, on one hand, by reducing the oxygen content in the molten glass, the reaction of the impurity Fe with O₂ to generate Fe³⁺ is inhibited; on the other hand, allowing the molten glass to form the weak reducing environment not only inhibits or even avoids the formation of Fe³⁺ and the Fe—O—Ti complex group, but also makes Fe²⁺ less prone to oxidation and stable in the molten glass.

In addition, during the high-temperature melting of the mixed batch, a large amount of gas will be separated from component raw materials of the mixed batch by decomposition during the initial melting of the mixed batch and can be discharged into the outside, with only a small amount of gas remaining in the molten glass and being present in the form of visible bubbles, physical dissolution, or chemical bonding. It can be seen that there is a certain equilibrium between the gas of the bubbles and the physically dissolved gas and the gas outside the molten glass. In the process that the high-temperature melting is continued to be performed, the impurity iron (Fe) in the molten glass can undergo a redox reaction with oxygen (O₂), and when the oxygen is sufficient, Fe³⁺ is easy to be generate. When the oxygen in the molten glass is consumed, the equilibrium between the gas of the visible bubbles and the physically dissolved gas in the molten glass and the gas outside the molten glass is broken, and oxygen outside the molten glass enters the molten glass, allowing the reaction of the impurity Fe in the molten glass with oxygen to be continued to be carried out, thereby causing the coloration of the glass to be increased.

The present disclosure chooses to introduce the gas into the molten glass for atmosphere bubbling after the mixed batch is melted and the molten glass is obtained, wherein the gas used for bubbling includes an inert gas and a reducing gas, and the inert gas has a specific gravity greater than that of air at the same temperature and atmospheric pressure to ensure that most of impurity gases separated out by decomposition during the melting of the raw materials are discharged to the outside the molten glass before the atmosphere bubbling so as to reduce gas impurities inside the molten glass. Since the inert gas introduced in the present disclosure has a specific gravity greater than that of air (at the same atmospheric pressure and temperature), the inert gas can escape from the molten glass and accumulate around the molten glass to form a gas protective layer, isolating the gas exchange between the inside of the molten glass and the outside. If the gas is introduced prior to melting of the mixed batch, the diffusion of the gas obtained after the decomposition of the mixed batch to the outside of the molten glass will be affected, thereby retaining a large amount of impurity gases within the molten glass.

In the present disclosure, the inert gas is mixed with the reducing gas to form a mixed gas prior to gas introduction for bubbling, and the mixed gas is introduced into the molten glass during the atmosphere bubbling. Due to the small solubility of the inert gas in the molten glass, the inert gas introduced into the molten glass can escape from the molten glass, and accumulate around the molten glass to form a gas protective layer to prevent the gas exchange between the inside of the molten glass and the outside and block gas from the outside of the molten glass from entering the inside of the molten glass, thereby reducing the oxygen content of the inside of the molten glass, thereby inhibiting the reaction of the impurity iron (Fe) in the molten glass with oxygen (O₂) to form Fe³⁺; and the reduced content of Fe³⁺ in the molten glass helps to inhibit the formation of the complex group Fe—O—Ti in the molten glass. Therefore, the inert gas introduced during the atmosphere bubbling helps to inhibit or even avoid the generation of Fe³⁺ and the complex group Fe—O—Ti in the molten glass, thereby contributing to the reduction of the coloration of the glass and the improvement of the light transmittance of the optical glass in the visible light region.

Further, the reducing gas introduced into the molten glass makes the molten glass form a weak reducing environment, the redox index of the molten glass is strictly controlled to be −120 to −5 in the present disclosure, and the degree of redox between components in the molten glass is reduced to help inhibit the rate and degree of the redox reaction of the impurity iron (Fe) in the molten glass with oxygen (O₂); and the molten glass forms the weak reducing environment, which also helps to make Fe²⁺ formed in the molten glass less prone to oxidation and stable in the molten glass; and it also helps to inhibit the rate and extent of the complexation reaction of Fe³⁺ with TiO₂ in the molten glass, and therefore, the introduction of the reducing gas helps to inhibit or even avoid the generation of Fe³⁺ and TiO₂ in the molten glass, thereby reducing the coloration of the glass. If the redox index of the molten glass is lower than −120, the reducing atmosphere formed in the molten glass is too remarkable, the container and the stirrer in contact with the molten glass are easily corroded during the melting process, a Pt flash point is easily generated when the container containing Pt and the stirrer containing Pt are used, which is disadvantageous for increasing the refractive index and the light transmittance of the optical glass; and if the redox index of the molten glass is higher than −5, the weak reducibility of the molten glass is not sufficient, which is disadvantageous for inhibiting the generation of Fe³⁺ and inhibiting the formation of the complex group Fe—O—Ti, and thus is disadvantageous for improving the light transmittance of the optical glass in the visible light region.

The redox index in the molten glass is one of the indices describing the electron transfer ability and rate in a chemical substance, and the redox index of the molten glass of the present disclosure refers to the sum of the redox indices of all the components in the molten glass. Since the glass components of the present disclosure are all neutral oxides, the inert gas is neutral, and chemically stable, the redox index of the molten glass of the present disclosure is primarily calculated as the redox index of the reducing gas introduced into the molten glass.

The redox index of the molten glass of the present disclosure is calculated as follows:

S=KRT
wherein K is an atmosphere coefficient, i.e., a change value of the redox index of the molten glass after 1 L of the reducing gas is introduced into the molten glass;
R is a flow rate of the reducing gas introduced into the molten glass per unit time; and
T is the time during which the reducing gas is introduced into the molten glass.

The redox index of the present disclosure is not limited to an integer and may be any number in the range of −120 to −5.

Further, since the inert gas introduced into the molten glass during the atmosphere bubbling can form a gas protective layer around the molten glass, it is avoided that some of the reducing gas introduced into the molten glass may diffuse to the outside of the molten glass, resulting in slow formation of a weak reducing environment in the molten glass. Therefore, the inert gas and the reducing gas which are simultaneously introduced in the molten glass act synergistically to help rapidly inhibit or even avoid the generation of Fe³⁺ and the Fe—O—Ti complex group in the molten glass, thereby reducing the coloration of the glass and increasing the light transmittance of the optical glass in the visible light region; and the simultaneous introduction of the inert gas and the reducing gas into the molten glass also helps to reduce the amount of the reducing gas used in the melting process, saving the cost.

Further, in the present disclosure, the container and the stirrer in contact with the molten glass during the high-temperature melting process are made of the platinum (Pt)-containing material. Due to the fact that a certain amount of heavy metals are contained in the special optical glass in the technical solution of the present disclosure, and the molten glass is in the weak reducing environment during melting, the molten glass has a certain corrosivity, and the corrosion of the molten glass is resisted by controlling the material of the container and the stirrer in contact with the molten glass during the melting process to be the platinum (Pt)-containing material in the present disclosure. The platinum-containing material of the present disclosure may be pure platinum or a platinum alloy such as a platinum tungsten alloy (≤5% by mass tungsten in the alloy) and a platinum ytterbium alloy (≤5% by mass ytterbium in the alloy). In the melting process of the present disclosure, strictly controlling the material of the container and the stirrer in contact with the molten glass improves the corrosion resistance of the container and the stirrer to the molten glass, avoiding the corrosion of the container and the stirrer by the molten glass of the present disclosure, thereby avoiding adverse effects on the optical homogeneity of the special optical glass, the refractive index and transmittance of the glass, etc., due to the container and the stirrer being corroded.

An apparatus for heating the mixed batch to melt the mixed batch during the high-temperature melting process is not particularly limited in the present disclosure as long as the high-temperature melting process of the present disclosure can be carried out. In some examples, the mixed batch is added into a pure platinum (Pt) crucible, and then the pure platinum (Pt) crucible containing the mixed batch is placed in a high-temperature melting furnace to be heated for melting in the present disclosure.

By adopting the method for preparing the optical glass provided by the present disclosure, the mixed batch is rationally designed so that the glass can not only achieve an ultra-high refractive index, but also reduce or even avoid the content of components that increase the coloration of the glass in the optical glass, and the inert gas is used to form a gas protective layer around the molten glass, inhibiting or even avoiding the generation of Fe³⁺ and the complex group Fe—O—Ti in the molten glass; further, the reducing gas makes the molten glass have a redox index of −120 to −5, enabling the molten glass to form a weak reducing environment, inhibiting the rate and extent of the redox reaction of the impurity Fe in the molten glass with oxygen during the high-temperature melting process, and allowing Fe²⁺ in the molten glass to be less prone to oxidation and stable in the molten glass, reducing or even avoiding the generation of Fe³⁺ in the optical glass; and at the same time, the complexation reaction of Fe³⁺ with TiO₂ can be inhibited, thereby reducing or even avoiding the generation of the complex group Fe—O—Ti in the molten glass. During the atmosphere bubbling, the inert gas and the reducing gas act synergistically to inhibit or even avoid the generation of Fe³⁺ and the complex group Fe—O—Ti in the molten glass, thus reducing the coloration of the glass, and allowing the prepared optical glass to have an ultra-high refractive index (n_{d}≥2.02 at a wavelength of 587.6 nm) and a high light transmittance (internal transmittance≥94.2% at a wavelength of 440 nm) in the visible light region, with good apparent quality of the glass. Also, the inert gas and the reducing gas introduced in the present disclosure have less residues in the molten glass compared with the decolorizing agent, and have less influence on the quality (e.g., purity and clarity) and the like of the optical glass compared with the prior art in which a decolorizing agent fluoride and carbon having corrosivity are added in order to alleviate the coloration of the glass. The optical glass according to the present disclosure can be produced at a low cost, can be easily produced in mass production, and is conducive to use and promotion, as raw materials of La₂O₃, which is a main component of the optical glass prepared according to the present disclosure, are cheap.

The apparent quality of the glass mainly includes indexes that can be directly observed by a naked eye such as the content of microbubbles in the glass, the homogeneity of the appearance of the glass, the coloration of the glass, and the presence or absence of a Pt flash point. The present disclosure considers optical glass having no microbubbles, uniform glass appearance, and no Pt flash point to have good apparent quality.

Based on the fact that the optical glass of the present disclosure contains an oxide that reduces the glass density, a drainage method is used to detect the density of the optical glass prepared in the present disclosure, the density of the optical glass prepared in the present disclosure is 5.21 g/cm³ or less, and a product further prepared by using the optical glass obtained in the present disclosure is easy to be light and thin.

In some examples, the inert gas is selected from at least one of argon, krypton and xenon, with the inert gas, the solubility in the molten glass is small, and the atomic diameter of these inert gases is relatively large, and the inert gas is not easily trapped by the network former in the molten glass during the atmosphere bubbling, so that these inert gases can rapidly escape from the molten glass after being introduced into the molten glass, causing the inert gases to rapidly accumulate around the molten glass to form a gas protective layer; in addition, these gases are all monatomic gases, which are not easily reactive, have stable physical and chemical properties, and have little influence on the melting of the molten glass during the high-temperature melting in the preparation of the optical glass; more importantly, these gases have poor thermal conductivity, and after these gases form the gas protective layer around the molten glass, heat transfer between the inside and the outside of the molten glass is reduced to a certain extent, so that the melting temperature required during the melting of the molten glass is reduced, thereby facilitating the suppression of the redox reaction between substances in the molten glass, thereby facilitating the reduction of the coloration of the glass and the increase of the internal transmittance of the glass in the visible light region. In addition to this, these inert gases can form large bubbles in the molten glass. During the clarification process, small impurity molecule gases remaining in the molten glass form small bubbles, which can be swallowed and dissolved by the large bubbles formed by the inert gases so that the small impurity molecules can be carried by the large bubbles formed by the inert gases to the surface of the molten glass to be cracked and eliminated. Inclusion of bubbles in the molten glass will affect the transparency of the glass, making the glass non-uniform or deformed; and the bubbles in the molten glass also reduce the strength of the glass, leading to fragility or rupture of the glass, therefore it is necessary to eliminate residual gases from the molten glass as much as possible.

In some examples, the reducing gas is selected from at least one of hydrogen, nitric oxide, hydrogen sulfide, sulfur monoxide and carbon monoxide, and these reducing gases have some solubility in the molten glass and tend to form a weak reducing environment in the molten glass.

Preferably, in the high-temperature melting process of the present disclosure, the inert gas used for the atmosphere bubbling is argon (Ar) and the reducing gas used for the atmosphere bubbling is hydrogen (H₂). Compared with the krypton and the xenon, a market price of the argon used in present disclosure is lower than that of the krypton and the xenon, thereby reducing the production cost of the glass and improving the economics of the glass; compared with nitric oxide, hydrogen sulfide, sulfur monoxide and carbon monoxide, the present disclosure employs H₂ as the reducing gas, this is due to the fact that the relative molecular mass of H₂ is the smallest, bubbles formed by H₂ in the molten glass are small during the clarification, and the bubbles formed by H₂ are more easily swallowed by large bubbles formed by Ar in the molten glass, and Ar can smoothly carry H₂ remaining in the molten glass to float to the surface of the molten glass to be cracked during the clarification, thereby allowing H₂ in the molten glass to be smoothly eliminated. As described above, the elimination of residual gases in the molten glass as much as possible is advantageous to improve the quality (e.g., transparency, homogeneity, etc.) of the optical glass.

In some examples, in the present disclosure, argon (Ar) and hydrogen (H₂) are mixed to form a mixed gas prior to the atmosphere bubbling, and the mixed gas is stored in a gas storage steel cylinder. The mixed gas has a hydrogen content of 1-3% by volume. During the atmosphere bubbling, the mixed gas is introduced into the molten glass at a flow rate of 1-4 L/min per liter of the molten glass for 0.5-1 h. The present disclosure strictly controls the volume percentage content of the hydrogen in the mixed gas, the flow rate of the mixed gas and the gas introducing time, which is not only beneficial for allowing sufficient Ar to be introduced into the molten glass prepared in the present disclosure to form a gas protective layer around the molten glass, in order to block the gas exchange between the inside of the molten glass and the outside, and is also beneficial for allowing an appropriate amount of H₂ to be introduced into the molten glass of the present disclosure so that the molten glass has a redox index of −120 to −5, thereby enabling the formation and maintenance of a weak reducing atmosphere in the molten glass. If the volume percentage content of H₂ in the mixed gas introduced into the molten glass is too low, the flow rate for the gas introducing is too small, and the gas introducing time is insufficient during the atmosphere bubbling, the amount of H₂ introduced into the molten glass is insufficient, and the reducing atmosphere formed in the molten glass is not significant, which is disadvantageous in increasing the light transmittance of the optical glass of the present disclosure in the visible light region; if the volume percentage content of the hydrogen in the mixed gas is too large, the flow rate of the gas introduced into the molten glass is too large, and the gas introducing time is too long, excess H₂ is introduced into the molten glass, and the reducing atmosphere formed in the molten glass is too significant, so that Ti ions mainly exist in the form of Ti³⁺ in the molten glass, the glass is purple, and the light transmittance of the optical glass in the visible light region is reduced; and in addition, there is also a risk of fire explosion if the volume percentage content of H₂ introduced into the molten glass is too high.

According to the method, when a mixed gas of argon and hydrogen is introduced into the molten glass and the content of the hydrogen in the mixed gas is 1-3% by volume, 1 L of the hydrogen is introduced into the molten glass, and a change value of the redox index of the molten glass is about −4.17, i.e., the K value during the calculation of the redox index of the molten glass is −4.17.

Preferably, in the method, the mixed gas is introduced into the molten glass by using a bubbler for bubbling. According to the present disclosure, the mixed gas is introduced into the molten glass through the bubbler for atmosphere bubbling, so that not only can the mixed gas be rapidly diffused uniformly in the molten glass so that Ar can rapidly escape from the molten glass, forming a gas protective layer around the molten glass, but also uniform diffusion of H₂ in the molten glass can be promoted, allowing the weak reducing environment of the molten glass to form rapidly.

In some examples, components in the optical glass include, in terms of the mass percentage of oxides, 40-50% La₂O₃, 15-25% Nb₂O₅, 10-20% Gd₂O₃, 5-10% GeO₂, 5-8% B₂O₃, 1-5% TiO₂, and 0.1-1% K₂O, wherein the sum of the mass percentages of La₂O₃, Nb₂O₅, Gd₂O₃, GeO₂ and TiO₂ is 82-92%; during the melting process, argon and hydrogen are introduced into the molten glass for atmosphere bubbling so that the molten glass has a redox index of −120 to −5, forming a weak reducing environment. The prepared optical glass has a higher refractive index (n_{d}≥2.05 at a wavelength of 587.6 nm) and a high light transmittance (internal transmittance≥94.2% at a wavelength of 440 nm) in the visible light region by further optimizing the contents of the above components in the present disclosure.

In some examples, during the preparation of the optical glass, the melting temperature is in the range of 1380-1420° C. and the melting time is in the range of 5-8 h. The temperature and time of the high-temperature melting are limited within reasonable range values, and on the premise of ensuring that the raw materials can be melted completely after high-temperature heating and melting of the mixed batch, a melting temperature as low as possible and a shorter melting time are used, inhibiting the reaction of the impurity Fe in the glass with the oxygen to form Fe³⁺, shortening the reaction time of the impurity Fe with the oxygen, thereby inhibiting or even avoiding the generation of Fe³⁺ in the glass, and indirectly inhibiting or even avoiding the formation of the complex group Fe—O—Ti, so as to reduce the coloration of the glass and improve the light transmittance of the optical glass in the visible light region.

In some examples, during the melting process, a frame stirrer is used for stirring at a speed of 50-80 rpm for 2-4 h to promote the clarification and homogenization of the molten glass.

The present disclosure selects an appropriate stirrer, stirring speed and stirring time, which not only contributes to the rapid elimination of residual gases from the molten glass so that the molten glass is clarified, and also helps to accelerate the homogenization of the molten glass, increasing preparation efficiency.

In some examples, the glass forming adopts a leakage forming method, and the forming temperature is 1200-1250° C.

The molten glass prepared by the above method of the present disclosure has a relatively low viscosity and therefore has a good fluidity, and the molten glass can be smoothly formed by the leakage forming method, and the surface smoothness of the glass obtained by the forming method is good. In addition, a suitable forming temperature is advantageous to increase the forming efficiency.

In some examples, the glass annealing temperature is 700-750° C. and the annealing time is 8-10 h.

By limiting the annealing temperature and the annealing time within reasonable range values, it is advantageous to better eliminate the stress in the optical glass, and to improve the transmittance of the glass in the visible light region and the mechanical strength of the glass.

In some examples, the optical glass includes, in terms of the mass percentage of oxides: 40-50% La₂O₃, 15-25% Nb₂O₅, 10-20% Gd₂O₃, 5-10% GeO₂, 5-10% B₂O₃, 1-6% TiO₂, 0.1-1% K₂O, 5-8% B₂O₃, 1-5% TiO₂, 1-6% ZrO₂, and 1-6% Ta₂O₅, wherein the sum of mass percentages of La₂O₃, Nb₂O₅, Gd₂O₃, GeO₂ and TiO₂ is 82-92%; the optical glass further includes 1-6% ZrO₂ and 1-6% Ta₂O₅; during melting, argon and hydrogen are introduced into the molten glass for atmosphere bubbling so that the molten glass has a redox index of −120 to −5, and the molten glass forms a weak reducing environment. The present disclosure can improve the alkali resistance and acid resistance of the glass by further adding Ta₂O₅ and ZrO₂ to make the optical glass have good chemical stability. When the mass percentage of the ZrO₂ component exceeds 6%, it is easy to cause devitrification of the glass, deteriorating glass forming properties of the glass, and a high temperature is required for complete dissolution of a large amount of ZrO₂, thereby increasing the melting temperature, which promotes the reaction of the impurity Fe in the molten glass with oxygen to generate Fe³⁺, which is disadvantageous to increase the light transmittance of the optical glass in the visible light region; and if the mass percentage of the ZrO₂ component is less than 1%, the chemical stability of the optical glass is not significantly improved. Therefore, the present disclosure strictly controls the mass percentage of the ZrO₂ component to be 1-6%, so that the obtained optical glass not only has good chemical resistance, but also has good glass forming properties, low melting temperature and good light transmittance in the visible light region. When the mass percentage of the Ta₂O₅ component exceeds 6%, it is easy to cause devitrification of the glass, deteriorating glass forming properties of the optical glass; when the mass percentage of the Ta₂O₅ component is less than 1%, the chemical stability of the optical glass is not significantly improved; and therefore, the present disclosure strictly controls the mass percentage of the Ta₂O₅ component to be 1-6%, so that the prepared optical glass is not only good in chemical resistance but also good in glass forming properties. The optical glass prepared in the present disclosure has a refractive index n_{d}≥2.02, alkali resistance stability of A₁ level and acid resistance stability of 1 level, and good chemical resistance, and the glass has high light transmittance (internal transmittance≥94.2% at a wavelength 440 nm) in the visible light region, the apparent quality of the glass is good, the optical glass prepared by the present disclosure has a density of 5.21 g/cm³ or less, and a product prepared using the optical glass of the present disclosure is easy to be light and thin.

The present disclosure provides optical glass, including, in terms of the mass percentage of oxides: 40-50% La₂O₃, 15-25% Nb₂O₅, 10-20% Gd₂O₃, 5-10% GeO₂, 5-10% B₂O₃, 1-6% TiO₂, 0.1-1% K₂O, 5-8% B₂O₃, and 1-5% TiO₂, wherein the sum of mass percentages of La₂O₃, Nb₂O₅, Gd₂O₃, GeO₂ and TiO₂ is 82-92%; the optical glass has a refractive index n_{d}≥2.02 and a transmittance≥94.2% in the visible light region. The apparent quality of the glass is good, the density of the optical glass prepared in the present disclosure is 5.21 g/cm³ or less, and a product prepared by using the optical glass according to the present disclosure is easy to be light and thin. The optical glass can be popularized and applied in the fields of virtual reality, digital cameras or vehicle-mounted display.

Preferably, the optical glass further includes, in terms of the mass percentage of oxides, 1-6% ZrO₂ and 1-6% Ta₂O₅; the prepared optical glass has a refractive index n_{d}≥2.02 and a transmittance≥94.2% in the visible light region, alkali resistance stability of A₁ level and acid resistance stability of 1 level. The apparent quality of the glass is good, the density of the optical glass prepared in the present disclosure is 5.21 g/cm³ or less, and a product prepared by using the optical glass according to the present disclosure is easy to be light and thin. Not only is the optical glass advantageous for promotion and use in the fields of virtual reality, digital cameras or vehicle-mounted display, but since the optical glass of the present disclosure has alkali resistance stability of A₁ level and acid resistance stability of 1 level, the optical glass of the present disclosure is further not afraid of scrubbing with various chemical agents, making the product more durable to use.

The present disclosure will be further described below with reference to the specific examples, but it cannot be understood as a limitation on the scope of protection of the present disclosure. Non-essential modifications and adjustments of the present disclosure made by those skilled in the art in light of the above contents of the present disclosure still fall within the scope of protection of the present disclosure.

Unless otherwise specified, the materials, reagents and the like referred to below are commercially available products well known to those skilled in the art; and unless otherwise specified, the methods are well known in the art. Unless defined otherwise, technical or scientific terms used shall have the usual meaning understood by those of ordinary skill in the art to which the present disclosure belongs.

In the glass provided in the examples and Comparative examples of the present disclosure, B₂O₃ and GeO₂ are base components and the corresponding raw materials are boric acid and germania, respectively; La₂O₃, Gd₂O₃, Nb₂O₅, TiO₂, ZrO₂, Ta₂O₅ and K₂O are functional components of the glass provided in the examples and Comparative examples of the present disclosure, and the functional components can be respective oxides themselves, corresponding carbonates or corresponding nitrates. These base components together with functional components are used to prepare ultra-high refractive index optical glass.

### Example 1

Corresponding masses of raw materials were weighed according to glass components in Table 1, and the raw materials were uniformly mixed to obtain a mixed batch. The mixed batch was added into a Pt crucible, and then the Pt crucible containing the mixed batch was placed in a high-temperature melting furnace to be heated to melt the mixed batch. After the mixed batch was melted, 4 L of molten glass was obtained. A mixed gas of argon and hydrogen was introduced into the molten glass through a bubbler for atmosphere bubbling, wherein the mixed gas has an argon content of 97% by volume, and a hydrogen content of 3% by volume, and the mixed gas was introduced at a flow rate of 1 L/min for 2 h. After the gas introducing was stopped, a Pt stirrer was used to mechanically stir the molten glass at a speed of 60 rpm for 3 h to homogenize and clarify the molten glass, wherein the melting temperature was 1380° C. and the melting time was 5 h. The homogenized and clarified molten glass was formed into a preheated mold at a temperature of 1250° C. by leakage. The formed glass was annealed at 710° C. for 10 h, and a power supply of an annealing furnace was turned off. The prepared glass was finally subjected to performance testing.

### Example 2

Corresponding masses of raw materials were weighed according to glass components in Table 1, and the raw materials were uniformly mixed to obtain a mixed batch. The mixed batch was added into a Pt crucible, and then the Pt crucible containing the mixed batch was placed in a high-temperature melting furnace to be heated to melt the mixed batch. After the mixed batch was melted, 4 L of molten glass was obtained. A mixed gas of argon and hydrogen was introduced into the molten glass through a bubbler for atmosphere bubbling, wherein the mixed gas has an argon content of 99% by volume, and a hydrogen content of 1% by volume, and the mixed gas was introduced at a flow rate of 1 L/min for 2.5 h. After the gas introducing was stopped, a Pt stirrer was used to mechanically stir the molten glass at a speed of 50 rpm for 4 h to homogenize and clarify the molten glass, wherein the melting temperature was 1400° C. and the melting time was 6.5 h. The homogenized and clarified molten glass was formed into a preheated mold at a temperature of 1200° C. by leakage. The formed glass was annealed at 700° C. for 8 h, and a power supply of an annealing furnace was turned off. The prepared glass was finally subjected to performance testing.

### Example 3

Corresponding masses of raw materials were weighed according to glass components in Table 1, and the raw materials were uniformly mixed to obtain a mixed batch. The mixed batch was added into a Pt crucible, and then the Pt crucible containing the mixed batch was placed in a high-temperature melting furnace to be heated to melt the mixed batch. After the mixed batch was melted, 4 L of molten glass was obtained. A mixed gas of argon and hydrogen was introduced into the molten glass through a bubbler for atmosphere bubbling, wherein the mixed gas has an argon content of 98% by volume, and a hydrogen content of 2% by volume, and the mixed gas was introduced at a flow rate of 2 L/min for 3 h. After the gas introducing was stopped, a Pt stirrer was used to mechanically stir the molten glass at a speed of 80 rpm for 2 h to homogenize and clarify the molten glass, wherein the melting temperature was 1420° C. and the melting time was 5 h. The homogenized and clarified molten glass was formed into a preheated mold at a temperature of 1220° C. by leakage. The formed glass was annealed at 750° C. for 10 h, and a power supply of an annealing furnace was turned off. The prepared glass was finally subjected to performance testing.

### Example 4

Corresponding masses of raw materials were weighed according to glass components in Table 1, and the raw materials were uniformly mixed to obtain a mixed batch. The mixed batch was added into a Pt crucible, and then the Pt crucible containing the mixed batch was placed in a high-temperature melting furnace to be heated to melt the mixed batch. After the mixed batch was melted, 4 L of molten glass was obtained. A mixed gas of argon and hydrogen was introduced into the molten glass through a bubbler for atmosphere bubbling, wherein the mixed gas has an argon content of 97% by volume, and a hydrogen content of 3% by volume, and the mixed gas was introduced at a flow rate of 3 L/min for 2 h. After the gas introducing was stopped, a Pt stirrer was used to mechanically stir the molten glass at a speed of 70 rpm for 3 h to homogenize and clarify the molten glass, wherein the melting temperature was 1400° C. and the melting time was 5 h. The homogenized and clarified molten glass was formed into a preheated mold at a temperature of 1240° C. by leakage. The formed glass was annealed at 730° C. for 8 h, and a power supply of an annealing furnace was turned off. The prepared glass was finally subjected to performance testing.

### Example 5

Corresponding masses of raw materials were weighed according to glass components in Table 1, and the raw materials were uniformly mixed to obtain a mixed batch. The mixed batch was added into a Pt crucible, and then the Pt crucible containing the mixed batch was placed in a high-temperature melting furnace to be heated to melt the mixed batch. After the mixed batch was melted, 4 L of molten glass was obtained. A mixed gas of argon and hydrogen was introduced into the molten glass through a bubbler for atmosphere bubbling, wherein the mixed gas has an argon content of 97% by volume, and a hydrogen content of 3% by volume, and the mixed gas was introduced at a flow rate of 3 L/min for 3 h. After the gas introducing was stopped, a Pt stirrer was used to mechanically stir the molten glass at a speed of 60 rpm for 3 h to homogenize and clarify the molten glass, wherein the melting temperature was 1420° C. and the melting time was 6 h. The homogenized and clarified molten glass was formed into a preheated mold at a temperature of 1250° C. by leakage. The formed glass was annealed at 710° C. for 9 h, and a power supply of an annealing furnace was turned off. The prepared glass was finally subjected to performance testing.

### Example 6

Corresponding masses of raw materials were weighed according to glass components in Table 1, and the raw materials were uniformly mixed to obtain a mixed batch. The mixed batch was added into a Pt crucible, and then the Pt crucible containing the mixed batch was placed in a high-temperature melting furnace to be heated to melt the mixed batch. After the mixed batch was melted, 4 L of molten glass was obtained. A mixed gas of argon and hydrogen was introduced into the molten glass through a bubbler for atmosphere bubbling, wherein the mixed gas has an argon content of 97% by volume, and a hydrogen content of 3% by volume, and the mixed gas was introduced at a flow rate of 4 L/min for 3.5 h. After the gas introducing was stopped, a Pt stirrer was used to mechanically stir the molten glass at a speed of 80 rpm for 2 h to homogenize and clarify the molten glass, wherein the melting temperature was 1380° C. and the melting time was 5.5 h. The homogenized and clarified molten glass was formed into a preheated mold at a temperature of 1200° C. by leakage. The formed glass was annealed at 720° C. for 10 h, and a power supply of an annealing furnace was turned off. The prepared glass was finally subjected to performance testing.

### Example 7

Corresponding masses of raw materials were weighed according to glass components in Table 1, and the raw materials were uniformly mixed to obtain a mixed batch. The mixed batch was added into a Pt crucible, and then the Pt crucible containing the mixed batch was placed in a high-temperature melting furnace to be heated to melt the mixed batch. After the mixed batch was melted, 4 L of molten glass was obtained. A mixed gas of argon and hydrogen was introduced into the molten glass through a bubbler for atmosphere bubbling, wherein the mixed gas has an argon content of 98% by volume, and a hydrogen content of 2% by volume, and the mixed gas was introduced at a flow rate of 2 L/min for 2 h. After the gas introducing was stopped, a Pt stirrer was used to mechanically stir the molten glass at a speed of 60 rpm for 3 h to homogenize and clarify the molten glass, wherein the melting temperature was 1400° C. and the melting time was 5 h. The homogenized and clarified molten glass was formed into a preheated mold at a temperature of 1250° C. by leakage. The formed glass was annealed at 750° C. for 8 h, and a power supply of an annealing furnace was turned off. The prepared glass was finally subjected to performance testing.

### Example 8

Corresponding masses of raw materials were weighed according to glass components in Table 1. Glass was prepared by the same method as that in Example 7.

### Example 9

Corresponding masses of raw materials were weighed according to glass components in Table 1. Glass was prepared by the same method as that in Example 7.

### Comparative Example 1

Corresponding masses of raw materials were weighed according to glass components in Table 2. Glass was prepared by the same method as that in Example 7.

### Comparative Example 2

Corresponding masses of raw materials were weighed according to glass components in Table 2. Glass was prepared by the same method as that in Example 7.

### Comparative Example 3

Corresponding masses of raw materials were weighed according to glass components in Table 2. Glass was prepared by the same method as that in Example 7. During glass preparation, only 95% by volume of Ar was introduced into the molten glass through a bubbler.

### Comparative Example 4

Corresponding masses of raw materials were weighed according to glass components in Table 2. A formula and preparation method for the glass were the same as those in Example 7.

No bubbling was performed during glass preparation.

### Comparative Example 5

Corresponding masses of raw materials were weighed according to glass components in Table 2. A formula and preparation method for the glass were the same as those in Example 7.

During glass preparation, a mixed gas of argon and hydrogen was introduced into the molten glass through a bubbler for atmosphere bubbling, wherein the mixed gas has an argon content of 97% by volume, and a hydrogen content of 3% by volume, and the mixed gas was introduced at a flow rate of 4 L/min for 4.5 h. The melting temperature was 1400° C. and the melting time was 7.5 h.

### Comparative Example 6

Corresponding masses of raw materials were weighed according to glass components in Table 2. A formula and preparation method for the glass were the same as those in Example 7. During glass preparation, a mixed gas of argon and hydrogen was introduced into the molten glass through a bubbler for atmosphere bubbling, wherein the mixed gas has an argon content of 99% by volume, and a hydrogen content of 1% by volume, and the mixed gas was introduced at a flow rate of 1 L/min for 1.5 h. The melting temperature was 1400° C. and the melting time was 4.5 h.

### Comparative Example 7

Corresponding masses of raw materials were weighed according to glass components in Table 2. A formula and preparation method for the glass were the same as those in Example 7. The difference from Example 7 was that the mixed batch was added into a corundum crucible, and after the gas introducing was stopped, a corundum stirrer is used to mechanically stir the molten glass during glass preparation.

### Comparative Example 8

Corresponding masses of raw materials were weighed according to glass components in Table 2. Glass was prepared by the same method as that in Example 7.

The ultra-high refractive index optical glass prepared in the Examples and the Comparative examples of the present disclosure was subjected to performance testing. The specific performance test results are shown in Tables 1 and 2 The refractive index was tested according to GB/T7962.1-2010 “Test methods of colorless optical glass—Part 1: Refractive index and coefficient of dispersion”.

Internal transmittance was tested according to a method in GB/T7962.12-2010 “Test methods of colorless optical glass—Part 12: Spectral internal transmittance”.

The alkali resistance stability was tested according to a method in GB/T6580-2021 “Glass-Resistance to attack by a boiling aqueous solution of mixed alkali-Method of test and classification”.

The acid resistance stability was tested according to a method in GB/T6581-2007 “Glass-Resistance to attack by hydrochloric acid at 100° C.-Flame emission or flame atomic absorption spectrometric method”.

TABLE 1
Components and performance test results of optical glass

| | Example | | | | | | | | |
|---|---|---|---|---|---|---|---|---|---|
| | 1 | 2 | 3 | 4 | 5 | 6 | 7 | 8 | 9 |
| La₂O₃ | 40 | 45 | 50 | 40 | 45 | 42 | 44 | 44 | 44 |
| Nb₂O₅ | 25 | 20 | 15 | 20 | 15 | 16 | 18 | 18 | 20 |
| Gd₂O₃ | 16.5 | 10 | 20 | 10 | 15 | 13 | 11.8 | 15.8 | 15 |
| GeO₂ | 5 | 10 | 5 | 8 | 5 | 7 | 6 | 6 | 8 |
| B₂O₃ | 5 | 5 | 5 | 7 | 10 | 8.8 | 8 | 8 | 8 |
| TiO₂ | 1 | 2 | 1 | 4.9 | 3 | 5 | 4 | 4 | 4.8 |
| ZrO₂ | 1 | 6 | 1 | 5 | 3 | 5 | 4 | 0 | 0 |
| Ta₂O₅ | 6 | 1 | 2.9 | 5 | 3.5 | 3 | 4 | 4 | 0 |
| K₂O | 0.5 | 1 | 0.1 | 0.1 | 0.5 | 0.2 | 0.2 | 0.2 | 0.2 |
| Redox index | −15.0 | −6.3 | −30.0 | −45.0 | −67.6 | −105.1 | −20.0 | −20.0 | −20.0 |
| Refractive index | 2.05246 | 2.08145 | 2.06324 | 2.05826 | 2.02473 | 2.02548 | 2.05632 | 2.05774 | 2.05826 |
| n_{d} | | | | | | | | | |
| Internal | 94.4 | 94.2 | 94.4 | 94.8 | 94.6 | 94.4 | 94.6 | 94.2 | 94.6 |
| transmittance | | | | | | | | | |
| Alkali resistance | A₁ | A₁ | A₁ | A₁ | A₁ | A₁ | A₁ | A₂ | A₃ |
| stability | | | | | | | | | |
| Acid resistance | 1 | 1 | 1 | 1 | 1 | 1 | 1 | 2 | 3 |
| stability | | | | | | | | | |
| Apparent quality | Good | Good | Good | Good | Good | Good | Good | Good | Good |
| Glass density | 5.18 | 5.21 | 5.21 | 5.19 | 5.18 | 5.16 | 5.18 | 5.19 | 5.21 |

TABLE 2
Components and performance test results of optical glass in comparative examples

| | Comparative example | | | | | | | |
|---|---|---|---|---|---|---|---|---|
| | 1 | 2 | 3 | 4 | 5 | 6 | 7 | 8 |
| La₂O₃ | 55 | 35 | 44 | 44 | 44 | 44 | 44 | 40 |
| Nb₂O₅ | 30 | 20 | 18 | 18 | 18 | 18 | 18 | 15 |
| Gd₂O₃ | 7 | 18 | 11.8 | 11.8 | 11.8 | 11.8 | 11.8 | 10 |
| GeO₂ | 0 | 5 | 6 | 6 | 6 | 6 | 6 | 7 |
| B₂O₃ | 4 | 10 | 8 | 8 | 8 | 8 | 8 | 10 |
| TiO₂ | 0 | 4.9 | 4 | 4 | 4 | 4 | 4 | 5 |
| ZrO₂ | 0 | 2 | 4 | 4 | 4 | 4 | 4 | 6 |
| Ta₂O₅ | 0 | 5 | 4 | 4 | 4 | 4 | 4 | 6 |
| K₂O | 4 | 0.1 | 0.2 | 0.2 | 0.2 | 0.2 | 0.2 | 1 |
| Redox | −20.0 | −20.0 | 0 | 0 | −135.1 | −20.0 | −3.8 | −20.0 |
| index | | | | | | | | |
| Refractive | / | 1.85241 | 2.05632 | 2.05632 | / | 2.05542 | / | 1.85621 |
| index n_{d} | | | | | | | | |
| Internal | / | 95.3 | 90.2 | 86.4 | / | 89.3 | / | 94.2 |
| transmittance | | | | | | | | |
| Alkali | / | A₁ | A₁ | A₁ | / | A₁ | / | A₁ |
| resistance | | | | | | | | |
| stability | | | | | | | | |
| Acid | / | 1 | 1 | 1 | / | 1 | / | 1 |
| resistance | | | | | | | | |
| stability | | | | | | | | |
| Apparent | Non-glass | Good | Good | Good | Having | Dark | Non-glass | Good |
| quality | forming | | | | a Pt | color | forming | |
| | | | | | flash | | | |
| | | | | | point | | | |
| Glass | / | 5.17 | 5.18 | 5.18 | 5.18 | 5.18 | / | 5.20 |
| density | | | | | | | | |

### Note:

The content of each oxide in Tables 1 and 2 is in % by mass; a detection wavelength of the refractive index n_{d} of the glass in Tables 1 and 2 was 587.6 nm; a detection wavelength of the internal transmittance (0%) of the glass was 440 nm; the acid resistance stability and the alkali resistance stability in Tables 1 and 2 are in level; and the density of the glass is in g/cm³.

As can be seen from Examples 1-9, Table 1 and Table 2, by using the method for preparing the optical glass according to the present disclosure, the optical glass includes, in terms of the mass percentage of oxides: 40-50% La₂O₃, 15-25% Nb₂O₅, 10-20% Gd₂O₃, 5-10% GeO₂, 5-10% B₂O₃, 1-6% TiO₂, and 0.1-1% K₂O, wherein the sum of mass percentages of La₂O₃, Nb₂O₅, Gd₂O₃, GeO₂ and TiO₂ is 82-92%; and during high-temperature melting of the mixed batch, after the mixed batch was melted, Ar and H₂ were introduced into the molten glass for atmosphere bubbling so that the molten glass had a redox index of −120 to −5, the obtained optical glass had an ultra-high refractive index (a refractive index n_{d}≥2.02 at a wavelength of 587.6 nm), a high light transmittance (internal transmittance≥94.2% at a wavelength of 440 nm) in the visible light region, and a density≤5.21 g/cm³, and the prepared optical glass had good apparent quality.

In connection with Examples 1-9 and Comparative example 1, it can be seen that when the optical glass contains only the B₂O₃ component and lacks GeO₂, glass is not formed. This is due to the fact that in the optical glass provided by the present disclosure, the GeO₂ component is an important network former of the optical glass provided by the present disclosure, and can improve the glass-forming ability of the glass. The B₂O₃ component is also an important network former of the optical glass provided by the present disclosure, and an essential component for enhancing the glass-forming ability of the glass.

As can be seen in connection with Examples 1-9 and Comparative example 2, the optical glass includes, in terms of the mass percentage of oxides: 15-25% Nb₂O₅, 10-20% Gd₂O₃, 5-10% GeO₂, 5-10% B₂O₃, 1-6% TiO₂, and 0.1-1% K₂O, wherein the sum of mass percentages of La₂O₃, Nb₂O₅, Gd₂O₃, GeO₂ and TiO₂ is 82-92%; and during the high-temperature melting of the mixed batch, after the mixed batch was melted, Ar and H₂ were introduced into the molten glass for atmosphere bubbling so that the redox index of the molten glass was −120 to −5, but if the mass percentage of La₂O₃ is less than 40%, the refractive index n_{d} of the prepared optical glass is less than 2.0.

In connection with Examples 1-9 and Comparative examples 3 and 4, it can be seen that by using the method for preparing the optical glass according to the present disclosure, during high-temperature melting, Ar and H₂ were introduced so that the redox index of the molten glass was −120 to −5, and the molten glass formed a weak reducing environment, which can significantly increase the light transmittance of the optical glass (internal transmittance≥94.2% at a wavelength of 440 nm) in the visible light region. As can be seen from Comparative example 3, in the preparation of the optical glass according to the present disclosure, only Ar was introduced during the high-temperature melting to form a neutral atmosphere in the molten glass, the molten glass did not form a weak reducing environment, and the light transmittance of the prepared glass in the visible light region was increased (internal transmittance of 90.2% at a wavelength of 440 nm), but compared with Examples 1-9, there is still room for improvement in the light transmittance of the glass in the visible light region. This is due to the fact that the mixed gas of Ar and H₂ was not used in Comparative example 3, and thus the molten glass does not form a reducing atmosphere, resulting in the formation of more Fe³⁺ from the impurity Fe in the glass, further increasing the content of the Fe—O—Ti complex group, increasing the coloration of the glass, and deteriorating the internal transmittance of the glass. In Comparative example 4, no atmosphere bubbling was performed during melting in the preparation of the optical glass, no weak reducing environment was formed in the molten glass, and the inside of the molten glass was not blocked from the outside atmosphere during the high-temperature melting, oxygen exchange between the inside of the molten glass and the outside can be achieved, oxygen in the molten glass continues to be sufficient, so that the redox reaction of the impurity Fe in the molten glass with the oxygen has a long duration and the oxidation reaction was complete, and the content of Fe³⁺ in an oxidation product in the molten glass increases, resulting in the production of more Fe³⁺ and the complex group Fe—O—Ti in the glass, so that the glass is more colored, so that the internal transmittance of the prepared optical glass is worse.

As can be seen in connection with Examples 1-7 and Examples 8-9, the optical glass includes 40-50% La₂O₃, 15-25% Nb₂O₅, 10-20% Gd₂O₃, 5-10% GeO₂, 5-10% B₂O₃, 1-6% TiO₂, and 0.1-1% K₂O, wherein the sum of mass percentages of La₂O₃, Nb₂O₅, Gd₂O₃, GeO₂ and TiO₂ is 82-92%; and during the high-temperature melting of the mixed batch, after the mixed batch was melted, Ar and H₂ were introduced into the molten glass for atmosphere bubbling so that the redox index of the molten glass was −120 to −5, and the optical glass also includes, in terms of mass percentage, 1-6% ZrO₂ and 1-6% Ta₂O₅; the prepared optical glass not only has an ultra-high refractive index (a refractive index n_{d}≥2.02 at a wavelength of 587.6 nm) and has high light transmittance (internal transmittance≥94.2% at a wavelength of 440 nm) in the visible light region, but also has excellent alkali resistance stability (A₁ level) and acid resistance stability (1 level), and the density of the glass is 5.21 g/cm³ or less, and the optical glass has good apparent quality.

As can be seen in connection with Examples 1-9, and Tables 1 and 2, in terms of mass percentage, raw materials for the optical glass include the following components: 40-50% La₂O₃, 15-25% Nb₂O₅, 10-20% Gd₂O₃, 5-10% GeO₂, 5-8% B₂O₃, 1-5% TiO₂, 1-6% ZrO₂, and 1-6% Ta₂O₅; and in the high-temperature melting process, Ar and H₂ were introduced for bubbling so that the redox index of the molten glass was −120 to −5, forming a weak reducing environment, and the obtained optical glass has a higher refractive index (n_{d}≥2.05 at a wavelength of 587.6 nm), a high light transmittance (internal transmittance≥94.2% at a wavelength of 440 nm) in the visible light region, and excellent alkali resistance stability (A1 level) and acid resistance stability (1 level), with better comprehensive performance.

As can be seen in conjunction with Examples 1-9, and Comparative examples 5 and 6, during glass preparation, the glass was prepared according to the mixed batch of the present disclosure, and Ar and H₂ were used when the molten glass was subjected to atmosphere bubbling so that the redox index of the molten glass was −120 to −5, and the molten glass formed a weak reducing environment, and the prepared optical glass has not only a high refractive index (n_{d}2.02 at a wavelength of 587.6 nm) but also a high light transmittance (internal transmittance≥94.2% at a wavelength of 440 nm) in the visible light region. If the amount of H₂ introduced during the melting process was too large to make the redox index of the molten glass lower than −120, the weak reducibility of the molten glass was too significant, and the molten glass has a corrosive effect on the melting container and the stirrer which are made of the Pt material used in the melting process, causing the prepared glass to have a Pt flash point. If the amount of H₂ introduced during the melting process was insufficient to make the redox index of the molten glass higher than −5, the weak reducibility of the molten glass was insufficient, the coloration of the glass was increased, and the light transmittance of the prepared optical glass in the visible light region was less than 90%.

In connection with Examples 1-9 and Comparative example 7, it can be seen that during the melting process, the container and the stirrer made of a platinum-containing material in contact with the molten glass were not used, but the melting apparatus and the stirrer made of corundum were only used, so that the corrosion resistance to the molten glass is insufficient, and the glass is not formed during the preparation of the optical glass.

In connection with Examples 1-9 and Comparative example 8, it can be seen that by using the method for preparing the optical glass according to the present disclosure, if the sum of the mass percentages of La₂O₃, Nb₂O₅, Gd₂O₃, GeO₂ and TiO₂ in the optical glass is less than 82%, the refractive index of the prepared optical glass is less than 2.0.

The technical features of the claims and/or the description of the present disclosure may be combined in a manner that is not limited to the combinations obtained by the references in the claims. The technical solution obtained by combining the technical features in the claims and/or the description is also within the protection scope of the present disclosure.

The above are only the preferred examples of the present disclosure and are not intended to limit the present disclosure in any way. Any simple amendments, equivalent changes, or modifications made to the above examples based on the technical essence of the present disclosure still fall within the scope of the technical solution of the present disclosure.

1. A method for preparing optical glass, wherein the method comprises the following steps:
(1) preparation of a mixed batch: weighing raw materials and mixing the raw materials uniformly, wherein the optical glass comprises, in terms of the mass percentage of oxides: 40-50% La₂O₃, 15-25% Nb₂O₅, 10-20% Gd₂O₃, 5-10% GeO₂, 5-10% B₂O₃, 1-6% TiO₂, and 0.1-1% K₂O, wherein the sum of mass percentages of La₂O₃, Nb₂O₅, Gd₂O₃, GeO₂ and TiO₂ is 82-92%;
(2) melting: melting the mixed batch to obtain molten glass, and then introducing a gas into the molten glass for atmosphere bubbling, wherein the gas comprises an inert gas and a reducing gas; the inert gas has a specific gravity greater than that of air at the same temperature and gas pressure; and the reducing gas makes the molten glass have a redox index of −120 to −5; after stopping the bubbling, homogenizing and clarifying the molten glass with stirring, wherein a container and a stirrer in contact with the molten glass during the melting process are made of a platinum-containing material; and
(3) glass forming and annealing.

2. The method of claim 1, wherein the inert gas is selected from at least one of argon, krypton and xenon; and the reducing gas is selected from at least one of hydrogen, nitric oxide, hydrogen sulfide, sulfur monoxide and carbon monoxide.

3. The method of claim 2, wherein the inert gas is argon and the reducing gas is hydrogen.

4. The method of claim 3, wherein the gas has a hydrogen content of 1-3% by volume, the gas is introduced at a flow rate of 1-4 L/min per liter of the molten glass for 0.5-1 h.

5. The method of claim 1, wherein in terms of mass percentage, the optical glass comprises 5-8% B₂O₃ and 1-5% TiO₂.

6. The method of claim 1, wherein the melting is performed at a temperature of 1380-1420° C. for 5-8 h; and the stirring is performed by using a frame stirrer at a speed of 50-80 rpm for 2-4 h.

7. The method of claim 1, wherein the glass forming adopts a leakage forming method, the forming temperature is 1200-1250° C., the glass annealing temperature is 700-750° C., and the annealing time is 8-10 h.

8. The method of claim 1, wherein in terms of oxides, the optical glass further comprises ZrO₂ and Ta₂O₅, and in terms of mass percentage, ZrO₂ is 1-6% and Ta₂O₅ is 1-6%.

9. Optical glass, wherein in terms of the mass percentage of oxides, the optical glass comprises 40-50% La₂O₃, 15-25% Nb₂O₅, 10-20% Gd₂O₃, 5-10% GeO₂, 5-10% B₂O₃, 1-6% TiO₂, 0.1-1% K₂O, 5-8% B₂O₃, and 1-5% TiO₂, wherein the sum of mass percentages of La₂O₃, Nb₂O₅, Gd₂O₃, GeO₂ and TiO₂ is 82-92%; and the optical glass has a refractive index n_{d} of 2.02 or more and a transmittance of 94.2% or more in a visible light region.

10. Use of the optical glass of claim 9 in the fields of virtual reality, digital cameras or vehicle-mounted display.
